(19) United States
(12) Patent Application Publication
(10) Pub. No.: US 2014/0372439 A1
(43) Pub. Date: Dec. 18, 2014

(54) SYSTEMS AND METHODS FOR CREATING A VISUAL VOCABULARY

(71) Applicant: Canon Kabushiki Kaisha, Tokyo (JP)

(72) Inventors: Juwei Lu, Irvine, CA (US); Bradley Scott Denney, Irvine, CA (US); Dariusz Dusberger, Irvine, CA (US)

(21) Appl. No.: 13/917,457

(22) Filed: Jun. 13, 2013

(51) Int. Cl. G06F 17/30

(52) U.S. Cl. CPC G06F 17/30705
USPC 707/737

(57) ABSTRACT

Systems, devices, and methods for creating a visual vocabulary extract a plurality of descriptors from one or more labeled images; cluster the descriptors into augmented-space clusters in an augmented space, wherein the augmented space includes visual similarities and label similarities; generate a descriptor-space cluster in a descriptor space based on the augmented-space clusters, wherein one or more augmented-space clusters are associated with the descriptor-space cluster; and generate augmented-space classifiers for the augmented-space clusters that are associated with the descriptor-space cluster based on the augmented-space clusters.

### BACKGROUND

1. Technical Field

This description generally relates to visual analysis of images.

2. Background

In the field of image analysis, images are often analyzed based on visual features. The features include shapes, colors, and textures. The features in the image can be detected and the content of the image can be guessed from the detected features.

### SUMMARY

In one embodiment a method for creating a visual vocabulary comprises extracting a plurality of descriptors from one or more labeled images; clustering the descriptors into augmented-space clusters in an augmented space, wherein the augmented space includes visual similarities and label similarities; generating a descriptor-space cluster in a descriptor space based on the augmented-space clusters, wherein one or more augmented-space clusters are associated with the descriptor-space cluster; and generating augmented-space classifiers for the augmented-space clusters that are associated with the descriptor-space cluster based on the augmented-space clusters.

In one embodiment a device for generating a visual vocabulary comprises one or more computer-readable media configured to store labeled images, and one or more processors that are coupled to the one or more computer-readable media and that are configured to cause the device to extract descriptors from one or more labeled images, wherein the labels include semantic information, and wherein extracted descriptors include visual information; augment the descriptors with semantic information from the labels; generate clusters of descriptors in an augmented space based on the semantic information and the visual information of the descriptors; generate a respective augmented-space classifiers for each one of the clusters of descriptors in the augmented space; generate clusters of descriptors in a descriptor space based on the clusters of descriptors in the augmented space, wherein two or more clusters of descriptors in the augmented space are associated with a corresponding cluster of descriptors in the descriptor space; and associate the two or more augmented-space classifiers for the two or more clusters of descriptors in the augmented space with the corresponding cluster of the clusters of descriptors in the descriptor space.

In one embodiment a method for encoding a descriptor comprises obtaining a descriptor; mapping the descriptor to a descriptor-space cluster in a descriptor space; applying a plurality of augmented-space classifiers that are associated with the descriptor-space cluster to the descriptor to generate respective augmented-space-classification scores; and generating a descriptor representation that includes the augmented-space-classification scores.

### BRIEF DESCRIPTION OF THE DRAWINGS

FIG. 1 illustrates an example embodiment of the operations that are performed by a system or device that generates a visual vocabulary.

FIG. 2 illustrates an example embodiment of an operational flow for generating a visual vocabulary.

FIG. 3 illustrates an example embodiment of an operational flow for generating a visual vocabulary.

FIG. 4 illustrates an example embodiment of an operational flow for generating classifiers.

FIG. 5 illustrates an example embodiment of an operational flow for encoding a descriptor.

FIG. 6 illustrates an example embodiment of the operations that are performed by a system or device that encodes a descriptor using a visual vocabulary.

FIG. 7 illustrates an example embodiment of the operations that are performed by a system or device that encodes a descriptor using a visual vocabulary.

FIG. 8 illustrates an example embodiment of the flow of encoding a descriptor.

FIG. 9 illustrates an example embodiment of a system for generating a visual vocabulary and encoding images.

FIG. 10A illustrates an example embodiment of a system for generating a visual vocabulary and encoding images.

FIG. 10B illustrates an example embodiment of a system for generating a visual vocabulary and encoding images.

### DESCRIPTION

The following disclosure describes certain explanatory embodiments. Other embodiments may include alternatives, equivalents, and modifications. Additionally, the explanatory embodiments may include several novel features, and a particular feature may not be essential to some embodiments of the devices, systems, and methods described herein.

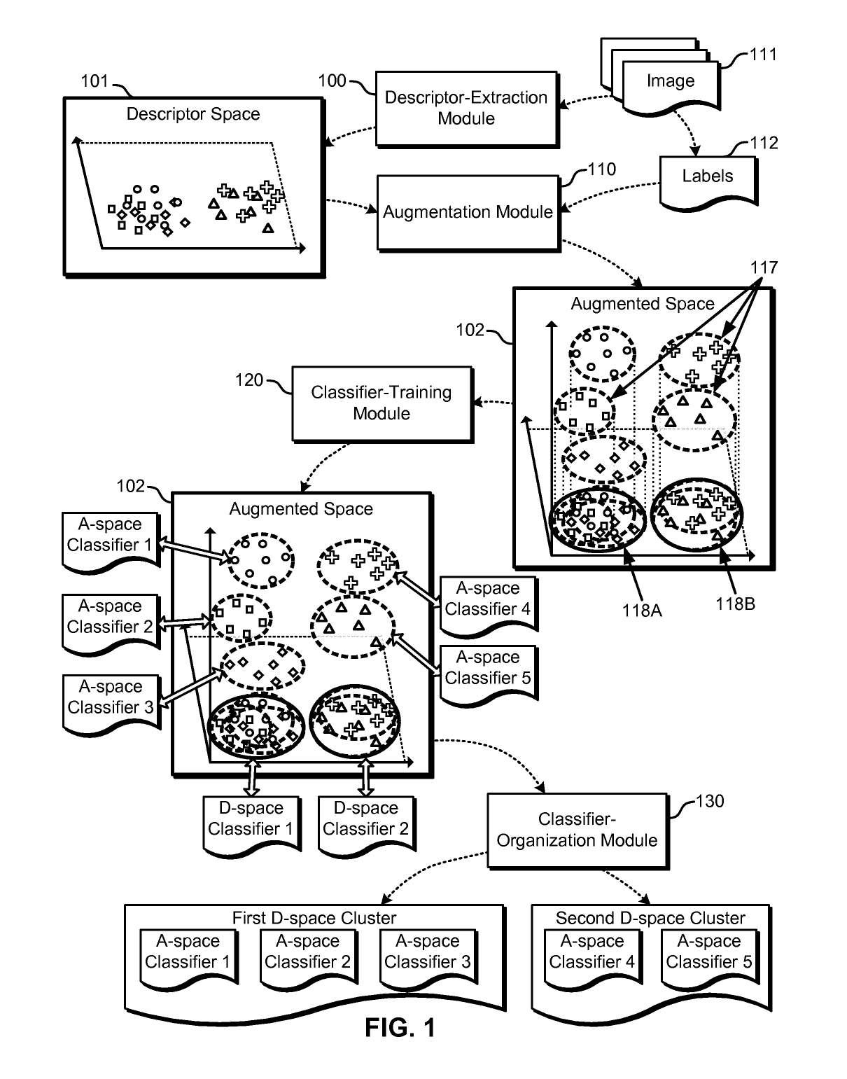

FIG. 1 illustrates an example embodiment of the operations that are performed by a system or device that generates a visual vocabulary. A visual vocabulary describes similar descriptors (e.g., SIFT, SURF, or HOG descriptors) with a visual word (e.g., a mapping of many descriptors to one visual word). An image may be represented by a vector (e.g., histogram) of visual words. To generate a visual vocabulary, the system generates augmented-space clusters (also referred to herein as “A-space clusters”) and additionally generates descriptor-space clusters (also referred to herein as “D-space clusters”) that each correspond to one or more of the A-space clusters. The system also generates a corresponding augmented-space classifier (also referred to herein as an “A-space classifier”) for each A-space cluster, thus generating, for each D-space cluster, one or more A-space classifiers (e.g., binary classifiers). The system also may generate a corresponding descriptor-space classifier (also referred to herein as a “D-space classifier”) for each D-space cluster.

Descriptors are extracted from one or more labeled images 111 by a descriptor-extraction module 100. The descriptors are initially defined in a descriptor space 101. The descriptor space 101 is a vector space that is defined by the basis vectors of the native attributes of the descriptors.

Modules (e.g., the descriptor-extraction module 100, an augmentation module 110, a classifier-training module 120) include logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the system includes additional or fewer modules, the modules are combined into fewer modules, or the modules are divided into more modules. Though the computing device or computing devices that execute a module perform the operations, for purposes of description a module may be described as performing one or more operations.

The descriptors and the labels 112 from the images 111 are obtained by an augmentation module 110, which maps the descriptors from the descriptor space 101 to an augmented space 102 (e.g., a topological space) based on the semantic information in the labels 112. For example, a label 112 of an image 111 (or the label 112 of a region of an image 111) may be associated with all of the descriptors that were extracted from the image 111. Therefore, if a first image is associated with the label “dog,” all of the descriptors that were extracted from the first image may be associated with the label “dog.” Additionally, each descriptor may be associated with one or more labels. Also, a distance between the labels is defined, for example according to an ontology. For example, “cat” and “dog” may be closer than “cat” and “truck.”

Sometimes semantic labels are assigned to one or more specific regions of an image (e.g., a label is assigned to some regions and not to other regions). Thus, an image may include labels that are generally assigned to the whole image and labels that are assigned to one or more regions in the image. The regions may be disjoint or overlapping. In some embodiments, if a descriptor extracted from an image is in one or more labeled regions of the image, then the descriptor is associated with the one or more labels that are assigned to the one or more regions. Else, if the descriptor is not from a labeled region but the image has one or more generally assigned labels, then the descriptor is associated with the one or more generally assigned labels. In some embodiments, the descriptor is associated with all of the labels, if any, of the regions that include the descriptor and with all of the generally assigned labels, if any, of the image from which the descriptor was extracted. Other embodiments may use other techniques to associate labels with descriptors.

Moreover, although the augmented space 102 illustrated by FIG. 1 has only one more dimension than the descriptor space 101, the augmented space 102 may have more than just one more dimension than the descriptor space 101. Also, in some embodiments, the augmented space 102 is not a coordinate space, the augmented space is not a vector space, or the augmented space includes a descriptor subspace and a semantic subspace. Additionally, in some embodiments the augmented space is a combination (e.g., Cartesian product) of two metric spaces, the first being a vector space of the descriptors, and the second being some non-vector metric space of labels. The augmented space 102, which describes semantic information, may be formed to make the application of certain distance metrics in the augmented space 102 easier, enhance the discriminability of the descriptors, make the descriptors easier to compare and analyze, preserve descriptor-to-descriptor dissimilarities, or preserve label-to-label dissimilarities. In some embodiments, the preservation is approximate. For example, descriptors can be augmented by choosing a function such that the Euclidean distance or dot product between any pair of descriptors augmented via the augmentation-function mapping is similar to the semantic-label distance or the semantic similarity, respectively, between the pair of descriptors. Thus, the function can be chosen based on some parametric form. In addition, the function may be subject to some smoothness constraints. In some embodiments, the dimensions of the augmented space 102 are not explicitly constructed, but instead a distance function describing the augmented space 102 can be constructed as a combination of distances in both the descriptor space and the label space. In some embodiments, the augmented space 102 is a transformed version of the descriptor space, such that a distance measure in the augmented space 102 best approximates the semantic distances of the descriptors.

The augmentation module 110 then clusters the descriptors in the augmented space 102 to form A-space clusters 117. The descriptors may be clustered by using, for example, k-means clustering, or an expectation-maximization algorithm. Also, D-space clusters 118 (which include D-space clusters 118A-B in this example) are generated based on the A-space clusters 117, for example by agglomerating the A-space clusters 117 that overlap when projected into the descriptor space 101.

A classifier-training module 120 then trains a respective A-space classifier (e.g., A-space classifiers 1-5) for each of the A-space clusters 117. In some embodiments, a classifier is a binary classifier. The classifier-training module 120 may train an A-space classifier with a one-against-all scheme by using the descriptors contained in the corresponding A-space cluster 117 as a positive sample set and the descriptors in the other A-space clusters 117 as a negative sample set. Accordingly, the discriminant information contained in the descriptors of an A-space cluster 117 is encoded into the corresponding classifier. This may prevent the loss of any significant semantic information. Also, in some embodiments a respective D-space classifier is trained for each of the D-space clusters 118.

A classifier-organization module 130 associates each D-space cluster 118 with the A-space classifiers of the component A-space clusters 117 of the D-space cluster 118. Assuming that there are K D-space clusters 118, then the k-th D-space cluster 118 has Mₖ classifiers associated with it. If Mₖ=1, then there is only one classifier associated with the D-space cluster 118. This one classifier may be a null classifier, and the output of the classifier may be 1. If Mₖ>1, then there are Mₖ classifiers, yₘ, m=1, . . . Mₖ, associated with the k-th D-space cluster 118. The Mₖ classifiers of the k-th D-space cluster 118 are the classifiers of the A-space clusters that compose the k-th D-space cluster 118. Thus, in FIG. 1, K=2. Also, for k=1 (the first D-space cluster), Mₖ=3, and for k=2 (the second D-space cluster), Mₖ=2.

Therefore, in FIG. 1, three A-space clusters 117 are agglomerated to form a first D-space cluster 118A, and the respective A-space classifiers of the three A-space clusters 117, which are A-space classifiers 1-3, are associated with the first D-space cluster 118A. Also, two other A-space clusters 117 are agglomerated to form a second D-space cluster 118B. The respective A-space classifiers of the two A-space clusters 117, which are A-space classifiers 4-5, are associated with the second D-space cluster 118B.

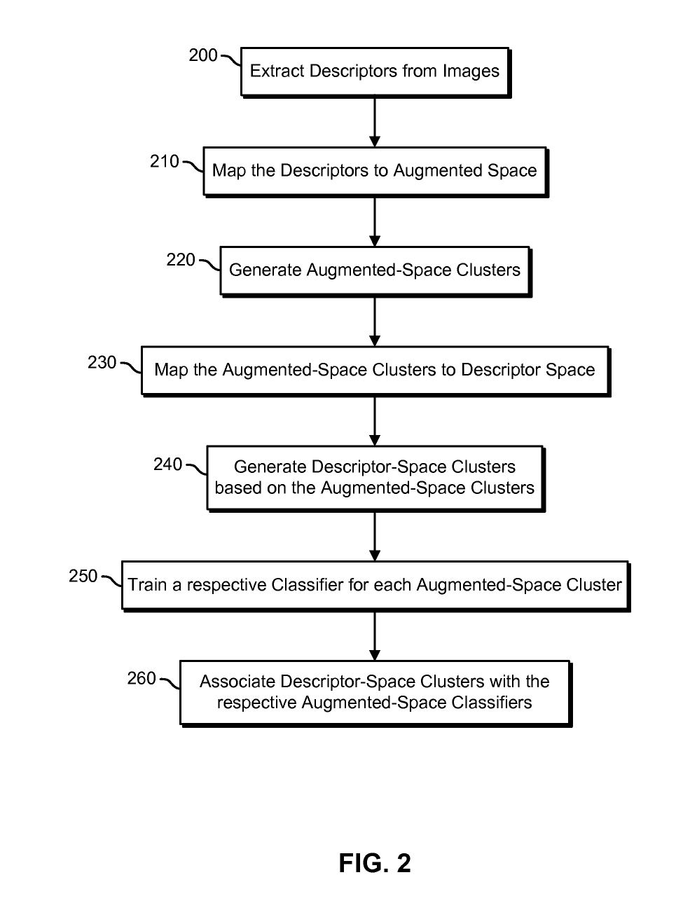

FIG. 2 illustrates an example embodiment of an operational flow for generating a visual vocabulary. The blocks of this operational flow and the other operational flows described herein may be performed by one or more computing devices, for example the systems and devices described herein. Also, although this operational flow and the other operational flows described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of this operational flow and the other operational flows described herein may omit blocks, add blocks, change the order of the blocks, combine blocks, or divide blocks into more blocks.

The flow starts in block 200, where descriptors are extracted from one or more images. Next, in block 210, the descriptors are mapped to augmented space. The flow then proceeds to block 220, where augmented-space clusters are generated.

Next, in block 230, the augmented-space clusters are mapped to the descriptor space. For example, the augmented-space clusters may be projected into the descriptor space. Then in block 240, descriptor-space clusters are generated based on the augmented-space clusters, for example by agglomerating the augmented-space clusters' projections in the descriptor space through an agglomerative-type clustering of the clusters or by a divisive clustering method.

Following, in block 250, a respective classifier is trained for each augmented-space cluster. Any applicable classifier-learning method may be used to train the classifiers. For example, let x be a descriptor representation in a descriptor space. In some example embodiments, the binary classifier is a linear SVM classifier, where

$$y = \{ \begin{matrix}1 , & if w \cdot x = b > 0 \\ 0 , & otherwise\end{matrix} , \qquad ( 1 )$$

and where w and b denote the normal vector to the optimal separating hyperplane and bias found by SVM, respectively.

Some embodiments use an AdaBoost-like method:

$$y = \frac{1}{T} {\sum }_{t = 1}^{T} {h}_{t} ( {x}_{t} ) , \qquad ( 2 )$$

where xₜ is an element of x, and

$${h}_{t} ( {x}_{t} ) = \{ \begin{matrix}{v}_{t} , & if {x}_{t} \geq {θ}_{t} \\ {u}_{t} , & otherwise\end{matrix} , with {v}_{t} , {u}_{t} ∈ [ - 1 , 1 ] , \qquad ( 3 )$$

where vₜ, uₜ, and θₜ are parameters of a stump classifier generated by AdaBoost learning.

Finally, in block 260, the descriptor-space clusters are associated with the applicable augmented-space classifiers (e.g., the augmented-space classifiers of the component augmented-space clusters of a corresponding descriptor-space cluster). For a D-space cluster containing only one (Mₖ=1) A-space cluster, a null classifier may be associated with the D-space cluster. The null classifier outputs 1 if the D-space cluster is activated and outputs 0 otherwise. In some embodiments, the activation of a cluster occurs when the D-space cluster is selected as the nearest D-space cluster to an input descriptor based on a standard k-means nearest-centroid assignment process. The final visual vocabulary (also referred to herein as “FVV”) includes the classifiers associated with the D-space clusters.

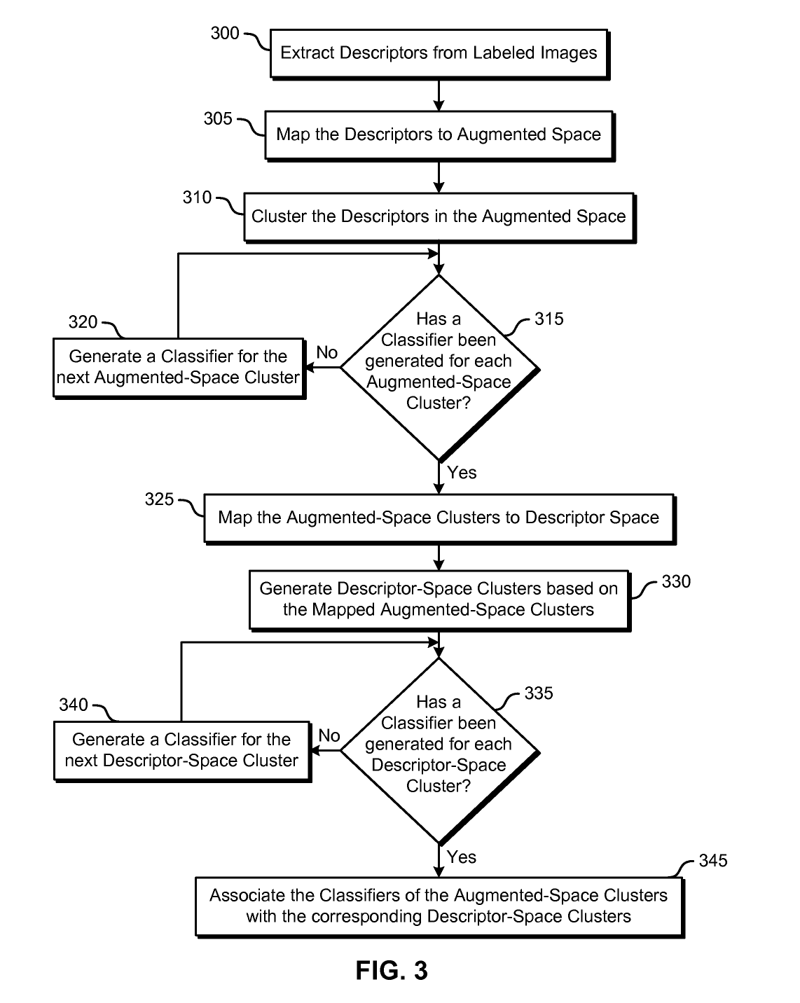

FIG. 3 illustrates an example embodiment of an operational flow for generating a visual vocabulary. The flow starts in block 300, where descriptors are extracted from labeled images (e.g., training images). Next, in block 305, based on the descriptors and their respective labels, the descriptors are mapped to an augmented space. Following, in block 310, the descriptors are clustered in the augmented space. The flow then moves to block 315, where it is determined if a classifier has been generated for each augmented-space cluster. If not (block 315=no), then the flow moves to block 320, where a classifier is generated for the next augmented space cluster, and then the flow returns to block 315. If a classifier has been generated for each augmented-space cluster (block 315=yes), then the flow moves to block 325. In block 325, the augmented-space clusters are mapped to (e.g., projected into) a descriptor space.

The flow then moves to block 330, where descriptor-space clusters are generated based on the mapped augmented-space clusters. Next, in block 335, it is determined if a classifier has been generated for each descriptor-space cluster. If not (block 335=no), then the flow proceeds to block 340, where a classifier is generated for the next descriptor-space cluster, and then the flow returns to block 335. If yes (block 335=yes), then the flow proceeds to block 345, where the augmented-space classifiers of the augmented-space clusters that compose a descriptor-space cluster are associated with the descriptor-space cluster or its classifier.

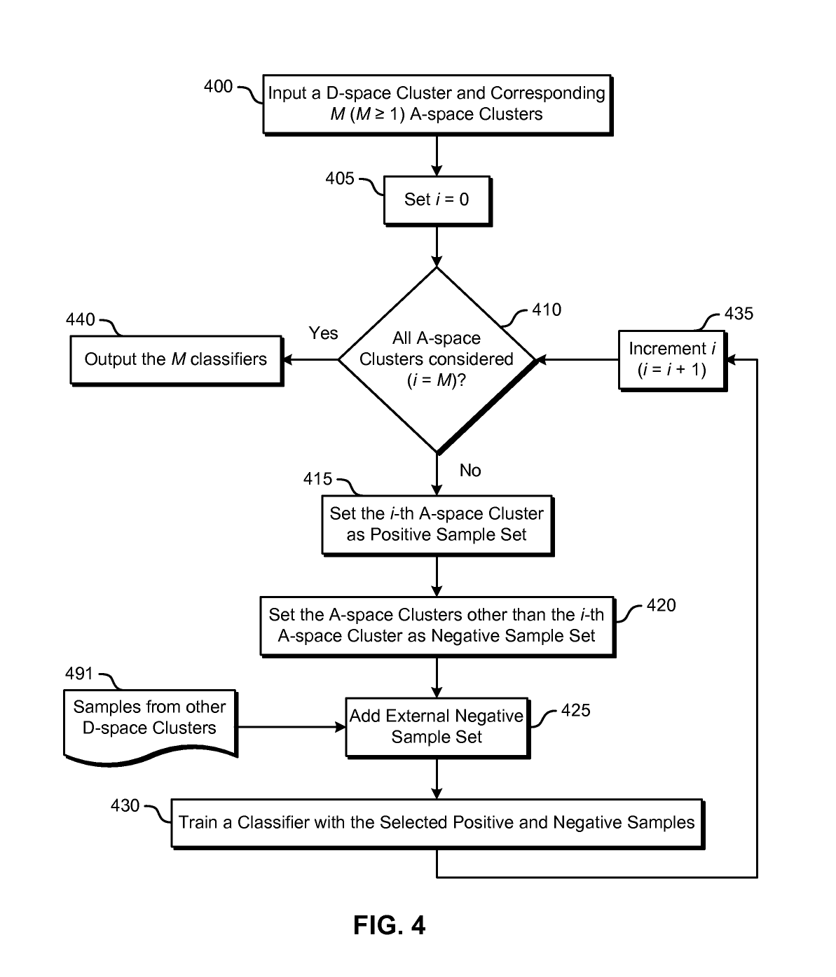

FIG. 4 illustrates an example embodiment of an operational flow for generating classifiers. For example, the operations of FIG. 4 may be performed by the classifier-training module 120 of FIG. 1 or may be performed during block 230 of FIG. 2 or block 320 of FIG. 3. To avoid over-fitting due to insufficient negative samples, in this embodiment the operations use an external data set, which includes samples from D-space clusters that are not associated with the A-space cluster for which a classifier is being generated. The operations randomly sample a subset of samples from the external set and add them to the negative sample set in order to train a binary classifier.

The flow starts in block 400, where a D-space cluster and its corresponding Mₖ A-space clusters are obtained. Next, in block 405, a counter i is set to 0. The flow then moves to block 410, where it is determined if all M A-space clusters have been considered (i=M). If not (block 410=no), the flow then proceeds to block 415, where the i-th A-space cluster is set as a positive sample set. Next, in block 420, the A-space clusters, other than the i-th A-space cluster, that are associated with the D-space cluster are set as a negative sample set. Following, in block 425, samples from other D-space clusters 491 are added as an external negative sample set. The flow then moves to block 430, where a classifier for the i-th A-space cluster is trained using the selected positive and negative samples.

Next, in block 435, the count i is incremented, and then the flow returns to block 410. If in block 410 it is determined that all M A-space clusters have been considered (i=M), the flow then proceeds to block 440, where the M A-space classifiers are output.

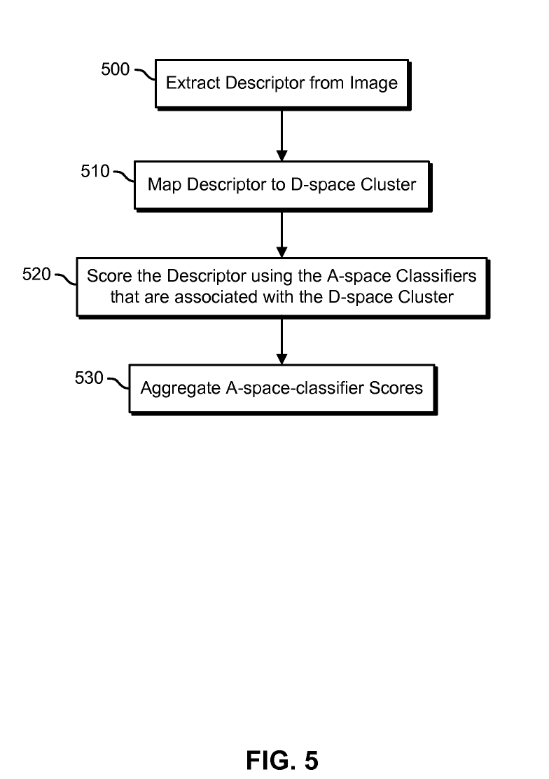

FIG. 5 illustrates an example embodiment of an operational flow for encoding a descriptor, which may be labeled or unlabeled. The flow starts in block 500, where a descriptor x is extracted from an image. Next, in block 510, the descriptor x is mapped to a D-space cluster. Some embodiments use a k-means assignment process, which assigns the input descriptor x to the nearest D-space cluster(s) in the vocabulary based on a certain distance measure between the descriptor x and the respective centroids of the D-space clusters. In some embodiments, the distance between the descriptor x and the k-th D-space-cluster centroid is a Euclidean distance that is calculated according to dₖ=∥x−cₖ∥, where cₖ denotes the center of the k-th D-space cluster centroid. If the k-th D-space-cluster centroid is the nearest one, or one of the nearest ones, to the descriptor x, the k-th D-space cluster may be considered to be “activated” and the other D-space clusters which are not the nearest or one of the nearest may be considered “unactivated.” The A-space classifiers associated with all unactivated D-space clusters output zeros in some embodiments.

Following, in block 520, the descriptor x is scored using the A-space classifiers that are associated with the activated D-space cluster, for example the Mₖ A-space classifiers, yₘ, m=1, . . . Mₖ, that are associated with the k-th D-space cluster. The output is the classification result of the Mₖ classifiers, [y₁(x), y₂(x), . . . , y_{M}_{ₖ}(x)].

Finally, in block 530, the A-space-classifier scores are aggregated. So the encoding V of the descriptor x is given by

V=[0, . . . ,0,y₁(x),y₂(x), . . . ,y_{M}_{ₖ}(x),0, . . . ,0]. (4)

In some embodiments, the encoding operations activate the J D-space clusters (J≦K) nearest to the input descriptor x. The output of each activated D-space cluster is then generated. The output of the j-th D-Cluster is an intermediate encoding Vⱼ, which may be calculated according to

Vⱼ=[0, . . . ,0,y_{j,1}(x),y_{j,2}(x), . . . ,y_{j,M}_{ₖ}(x),0, . . . ,0]. (5)

The outputs of all the activated D-space clusters may be aggregated to get the final encoding V of the descriptor x, where

V=Σⱼ₌₁^{J}pⱼ·Vⱼ, (6)

and where pⱼ is a weight that indicates the significance of the corresponding D-space cluster.

Some embodiments determine the weights based on the respective distances between the input descriptor x and the D-space clusters, for example according to

$${p}_{j} = \frac{1}{Z} exp ( - {d}_{j}^{2} / {σ}^{2} ) , \qquad ( 7 )$$

where σ is a constant, dⱼ is a distance between the descriptor x and the j-th D-space cluster, and Z is a normalization parameter to make Σⱼ₌₁^{J}pⱼ=1. As stated previously, in some embodiments the distance is a Euclidean distance, dⱼ=∥x−cⱼ∥, where cⱼ denotes the center (or centroid) of the j-th D-space cluster.

Additionally, in some embodiments, the encoding further describes attribute features. C={zₖ}ₖ₌₁^{C} represents the semantic-label sets used to create a semantic subspace in an augmented space. In augmented space, each generated A-space cluster may contain one or more semantic labels. A C-dimensional label histogram B can be generated from an A-space cluster, for example according to

B=[b₁,b₂, . . . ,b_{C}], (8)

where bᵢ is a count of samples with the label zᵢ in the A-space cluster. For example, such a label histogram may be built for each A-space cluster during vocabulary learning. Then each histogram is associated with a classifier learned from its corresponding A-space cluster. As a result, a classifier outputs not only a classification decision, but also a histogram of labels, which can be considered to be a set of semantic attributes associated with the decision.

Given an input descriptor x, its semantic attributes may be extracted by using the learned attribute histograms during an encoding phase. Some embodiments generate a C-dimensional attribute-feature vector according to

$$A = \frac{1}{Z} {\sum }_{m = 1}^{{M}_{k}} {y}_{m} ( x ) \cdot {B}_{m} , \qquad ( 9 )$$

where Bₘ is the attribute histogram associated with the m-th classifier of the activated D-space cluster, and where Z is a normalization constant (e.g., for an L1 normalization).

Some embodiments activate the J nearest D-space clusters. These embodiments can generate a C-dimensional attribute-feature vector through a weighted linear combination of J individual attribute-feature vectors, for example according to

A=Σⱼ₌₁^{J}pⱼ·Aⱼ, (10)

where Aⱼ is the attribute-feature vector generated from the j-th D-space cluster (e.g., according to equation (9)), and where pⱼ is the weights (e.g., according to equation (7)).

Finally, attribute-feature vectors generated according to equation (9) or equation (10) can be combined with a bag-of-visual feature vector generated according to equation (4) or equation (6), respectively, via a concatenation or a weighted concatenation, for example. The combined feature representation may provide enhanced discriminative power and may be used for general image recognition and retrieval.

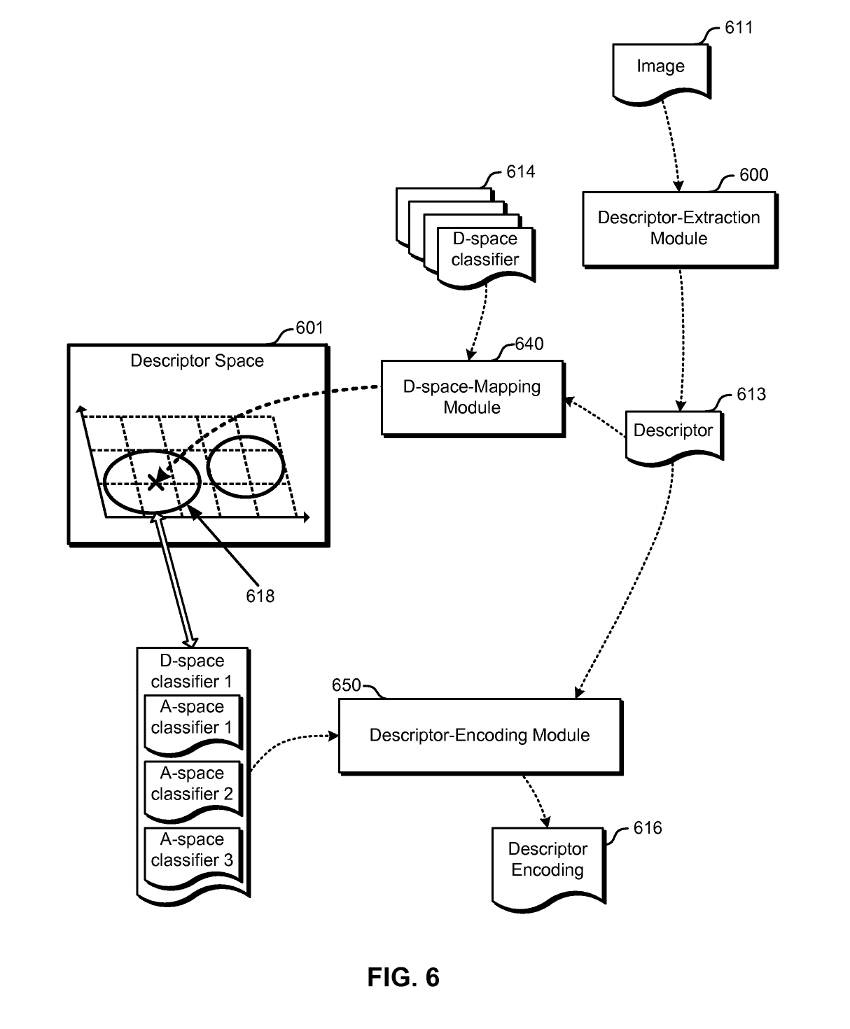

FIG. 6 illustrates an example embodiment of the operations that are performed by a system or device that encodes a descriptor using a visual vocabulary. An image 611 is obtained by a descriptor-extraction module 600, which extracts a descriptor 613 from the image 611. A D-space-mapping module 640 obtains the descriptor 613 and one or more D-space classifiers 614 and, based on the descriptor 613 and the one or more D-space classifiers 614, determines and activates the associated D-space cluster 618 of the descriptor 613. The descriptor 613 may or may not be explicitly mapped to descriptor space 601.

A descriptor-encoding module 650 then obtains the descriptor 613 and the A-space classifier(s) that are associated with the activated D-space cluster 618, and, based on them, generates a descriptor encoding 616, for example according to equation (4) or equation (9).

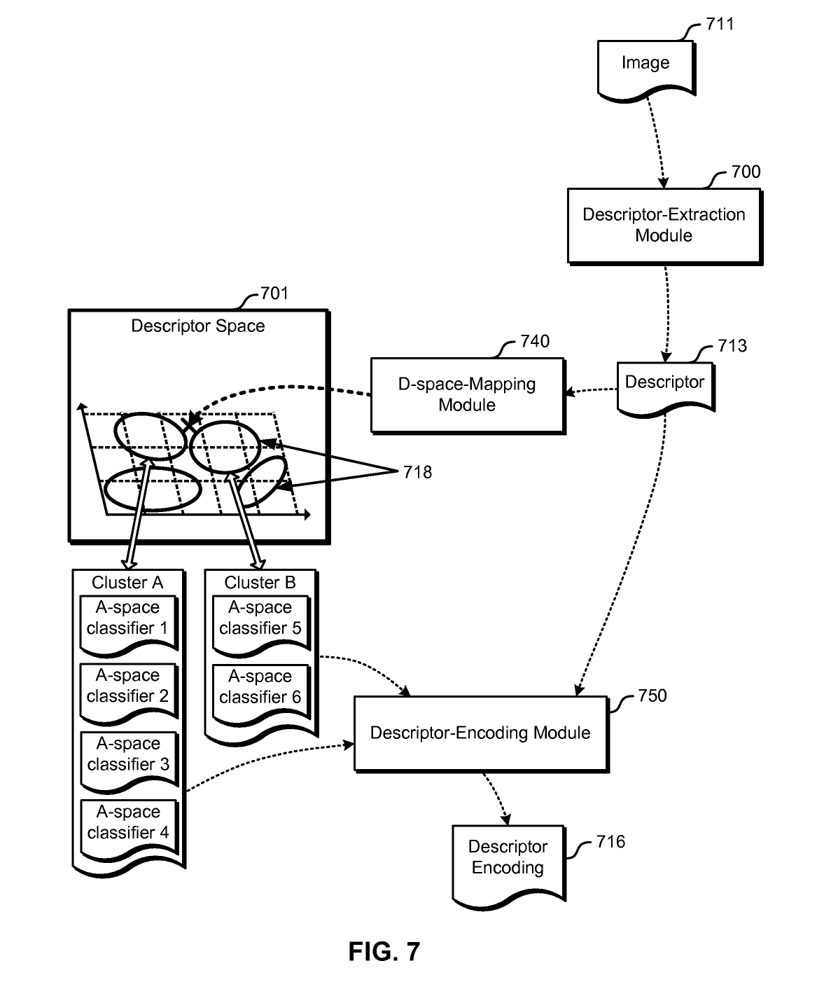

FIG. 7 illustrates an example embodiment of the operations that are performed by a system or device that encodes a descriptor using a visual vocabulary. An image 711 is obtained by a descriptor-extraction module 700, which extracts a descriptor 713 from the image 711. A D-space-mapping module 740 obtains the descriptor 713, maps the descriptor 713 to D-space 701, and determines and activates the J D-space clusters 718 that are nearest to the descriptor 713 in D-space 701. In this example J=2.

A descriptor-encoding module 750 then obtains the descriptor 713 and the A-space classifier(s) that are associated with the two activated D-space clusters 718, and, based on them, generates a descriptor encoding 716, for example according to equation (6) or equation (10).

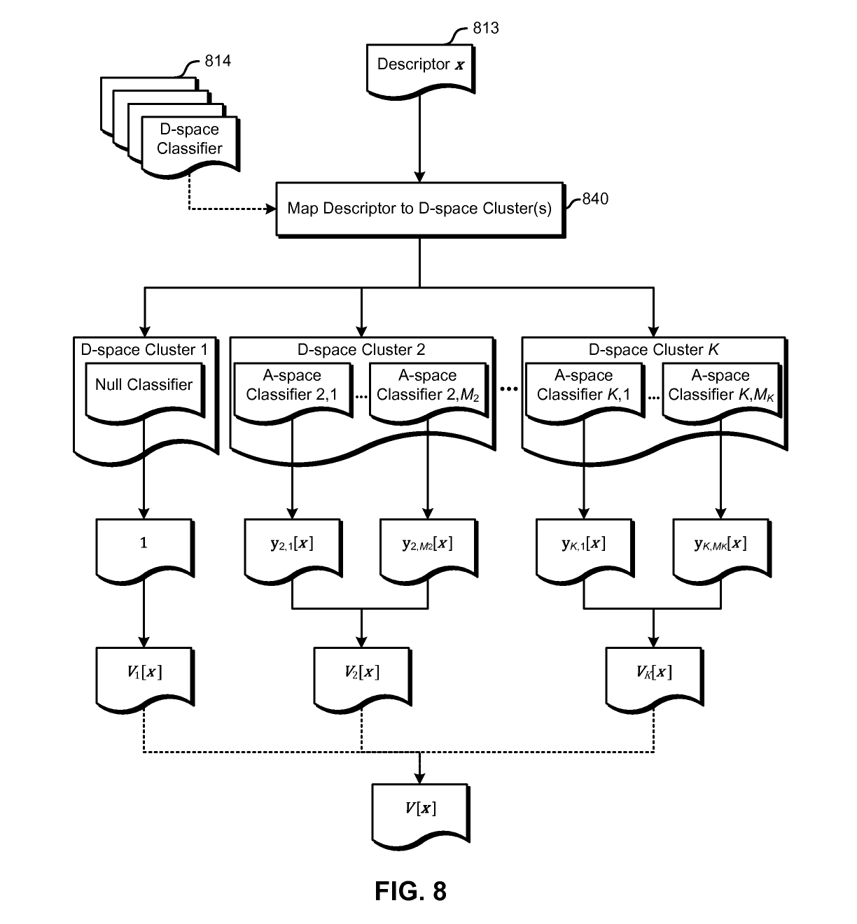

FIG. 8 illustrates an example embodiment of the flow of encoding a descriptor. A descriptor 813 is mapped to one or more D-space clusters in block 840. In some embodiments, the mapping is based on one or more D-space classifiers 814. Next, the descriptor 813 is input to the A-space classifiers that are associated with the activated one or more D-space clusters. In this embodiment, D-space cluster 1 is associated with a null classifier, which outputs a 1 if D-space cluster 1 is activated, 0 otherwise. The respective classifier outputs y_{j,1}(x), y_{j,2}(x), . . . , y_{j,M}_{ₖ} of each of the JA-space classifiers of the activated D-space clusters are merged to form respective intermediate encodings Vⱼ. If more than one D-space cluster is activated, then the intermediate encodings Vⱼ of the activated D-space clusters are merged to generate the final encoding V of the descriptor 813. If only one D-space cluster is activated, then its intermediate encoding Vⱼ may be used as the final encoding V.

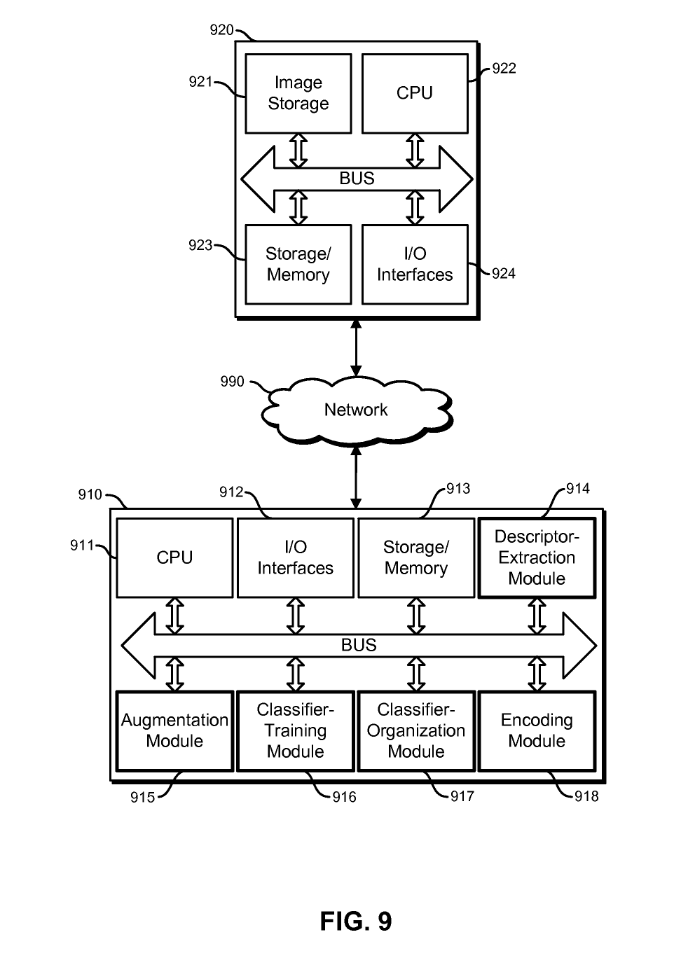

FIG. 9 illustrates an example embodiment of a system for generating a visual vocabulary and encoding images. The system includes a vocabulary-generation device 910 and an image-storage device 920. The vocabulary-generation device 910 includes one or more processors (CPU) 911, I/O interfaces 912, and storage/memory 913. The CPU 911 includes one or more central processing units, which include microprocessors (e.g., a single core microprocessor, a multi-core microprocessor) or other circuits, and is configured to read and perform computer-executable instructions, such as instructions stored in storage or in memory (e.g., in modules that are stored in storage or memory). The computer-executable instructions may include those for the performance of the operations described herein. The I/O interfaces 912 include communication interfaces to input and output devices, which may include a keyboard, a display, a mouse, a printing device, a touch screen, a light pen, an optical-storage device, a scanner, a microphone, a camera, a drive, and a network (either wired or wireless).

The storage/memory 913 includes one or more computer-readable or computer-writable media, for example a computer-readable storage medium or a transitory computer-readable medium. A computer-readable storage medium is a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). A transitory computer-readable medium, for example a transitory propagating signal (e.g., a carrier wave), carries computer-readable information. The storage/memory 913 is configured to store computer-readable data or computer-executable instructions. The components of the vocabulary-generation device 910 communicate via a bus.

The vocabulary-generation device 910 also includes a descriptor-extraction module 914, an augmentation module 915, a classifier-training module 916, a classifier-organization module 917, and an encoding module 918. In some embodiments, the vocabulary-generation device 910 includes additional or fewer modules, the modules are combined into fewer modules, or the modules are divided into more modules. The descriptor-extraction module 914 includes instructions that, when executed by the vocabulary-generation device 910, cause the vocabulary-generation device 910 to obtain one or more images (e.g., from the image-storage device 920) and extract one or more descriptors from the images. The augmentation module 915 includes instructions that, when executed by the vocabulary generation device 910, cause the vocabulary-generation device 910 to map descriptors to an augmented space, generate descriptor clusters in the augmented space, or generate descriptor clusters in the descriptor space. The classifier-training module 916 includes instructions that, when executed by the vocabulary-generation device 910, cause the vocabulary-generation device 910 to train augmented-space classifiers for the augmented-space clusters or train descriptor-space classifiers for the descriptor-space clusters. The classifier-organization module 917 includes instructions that, when executed by the vocabulary-generation device 910, cause the vocabulary-generation device 910 to associate augmented-space classifiers with respective ones of the descriptor-space clusters. The encoding module 918 includes instructions that, when executed by the vocabulary-generation device 910, cause the vocabulary-generation device 910 to map descriptors to one or more descriptor-space clusters and encode descriptors with scores generated by the augmented-space classifiers that are associated with the activated one or more descriptor-space clusters.

The image-storage device 920 includes a CPU 922, storage/memory 923, I/O interfaces 924, and image storage 921. The image storage 921 includes one or more computer-readable media that are configured to store images. The image-storage device 920 and the vocabulary-generation device 910 communicate via a network 990.

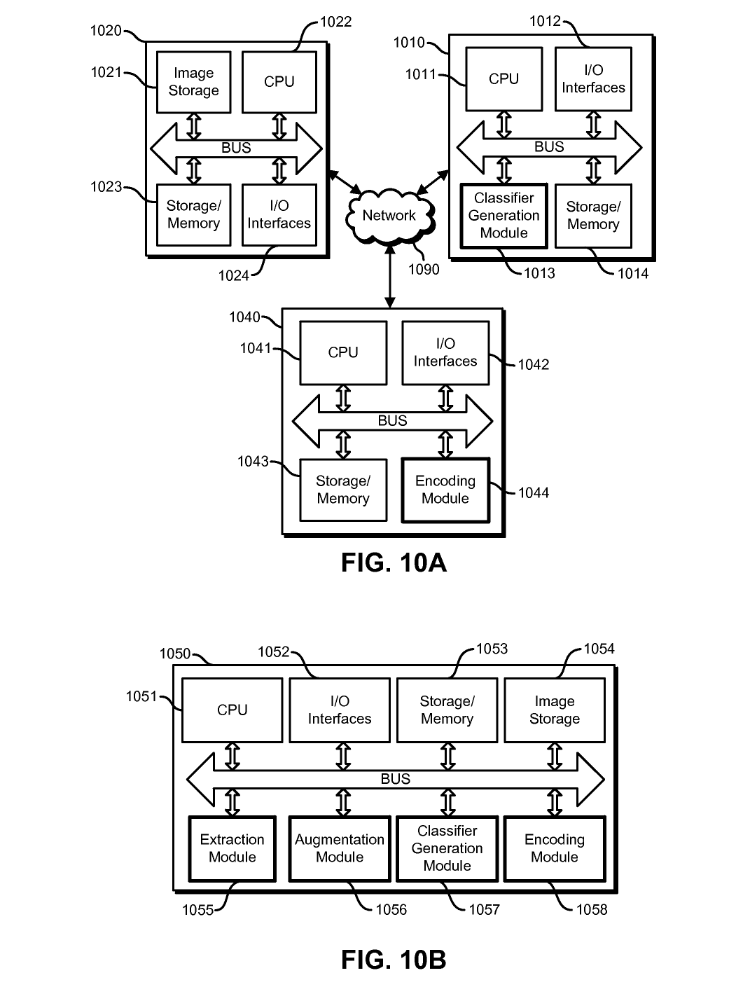

FIG. 10A illustrates an example embodiment of a system for generating a visual vocabulary and encoding images. The system includes an image-storage device 1020, a vocabulary-generation device 1010, and an encoding device 1040, which communicate via a network 1090. The image-storage device 1020 includes one or more CPUs 1022, I/O interfaces 1024, storage/memory 1023, and image storage 1021. The vocabulary-generation device 1010 includes one or more CPUs 1011, I/O interfaces 1012, storage/memory 1014, and a classifier-generation module 1013, which includes the functionality of the descriptor-extraction module 914, the augmentation module 915, the classifier-training module 916, and the classifier-organization module 917 of FIG. 9. The encoding device 1040 includes one or more CPUs 1041, I/O interfaces 1042, storage/memory 1043, and an encoding module 1044.

FIG. 10B illustrates an example embodiment of a system for generating a visual vocabulary. The system includes a vocabulary-generation device 1050. The vocabulary-generation device 1050 includes one or more CPUs 1051, I/O interfaces 1052, storage/memory 1053, an image-storage module 1054, a descriptor-extraction module 1055, an augmentation module 1056, a classifier-generation module 1057, and an encoding module 1058. This embodiment of the classifier-generation module 1057 includes the functionality of the classifier-training module 916 and the classifier-organization module 917 of FIG. 9. Thus, in this example embodiment of the vocabulary-generation device 1050, a single device performs all the operations and stores all the applicable information.

The above-described devices, systems, and methods can be implemented by providing one or more computer-readable media that contain computer-executable instructions for realizing the above-described operations to one or more computing devices that are configured to read and execute the computer-executable instructions. Thus, the systems or devices perform the operations of the above-described embodiments when executing the computer-executable instructions. Also, an operating system on the one or more systems or devices may implement at least some of the operations of the above-described embodiments. Thus, the computer-executable instructions or the one or more computer-readable media that contain the computer-executable instructions constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A method for creating a visual vocabulary, the method comprising:
extracting a plurality of descriptors from one or more labeled images;
clustering the descriptors into augmented-space clusters in an augmented space, wherein the augmented space includes visual similarities and label similarities;
generating a descriptor-space cluster in a descriptor space based on the augmented-space clusters, wherein one or more augmented-space clusters are associated with the descriptor-space cluster; and
generating augmented-space classifiers for the augmented-space clusters that are associated with the descriptor-space cluster based on the augmented-space clusters.

2. The method of claim 1, wherein the descriptor space is a subspace of the augmented space.

3. The method of claim 1, wherein an augmented-space classifier is configured to generate a classifier score that indicates a likelihood of a descriptor in the descriptor-space cluster mapping to a respective augmented-space cluster that is associated with the descriptor-space cluster.

4. The method of claim 1, wherein an augmented-space classifier is a binary classifier.

5. The method of claim 1, wherein the descriptor-space cluster is generated at least in part by merging two or more augmented-space clusters that are projected into the descriptor space.

6. The method of claim 5, wherein projections of the merged two or more augmented-space clusters are proximally located in the descriptor space.

7. The method of claim 1, further comprising creating a representation for an image based on the augmented-space classifiers.

8. A device for generating a visual vocabulary, the device comprising:
one or more computer-readable media configured to store labeled images; and
one or more processors that are coupled to the one or more computer-readable media and that are configured to cause the device to
extract descriptors from one or more labeled images, wherein the labels include semantic information, and wherein extracted descriptors include visual information;
augment the descriptors with semantic information from the labels;
generate clusters of descriptors in an augmented space based on the semantic information and the visual information of the descriptors;
generate a respective augmented-space classifiers for each one of the clusters of descriptors in the augmented space;
generate clusters of descriptors in a descriptor space based on the clusters of descriptors in the augmented space, wherein two or more clusters of descriptors in the augmented space are associated with a corresponding cluster of descriptors in the descriptor space; and
associate the two or more augmented-space classifiers for the two or more clusters of descriptors in the augmented space with the corresponding cluster of the clusters of descriptors in the descriptor space.

9. The device of claim 8, wherein the one or more processors are further configured to cause the device to generate a respective descriptor-space classifier for each one of the clusters of descriptors in the descriptor space.

10. The device of claim 8, wherein generating a respective augmented-space classifiers for a cluster of descriptors in the augmented space includes using the descriptors in the cluster of descriptors as positive samples and using the descriptors in the other clusters of descriptors as negative samples.

11. The device of claim 8, wherein the one or more processors are further configured to generate the clusters of descriptors in the descriptor space based on the clusters of descriptors in the augmented space at least in part by agglomerating the clusters of descriptors in the augmented space.

12. The device of claim 11, wherein the agglomerating of the clusters of descriptors in the augmented space is based on projections to the descriptor space of the clusters of descriptors in the augmented space.

13. A method for encoding a descriptor, the method comprising:
obtaining a descriptor;
mapping the descriptor to a descriptor-space cluster in a descriptor space;
applying a plurality of augmented-space classifiers that are associated with the descriptor-space cluster to the descriptor to generate respective augmented-space-classification scores; and
generating a descriptor representation that includes the augmented-space-classification scores.

14. The method of claim 13, wherein the augmented-space-classification scores each indicate a respective likelihood of the descriptor belonging to a respective augmented-space cluster.
